(19) United States
(12) Patent Application Publication
(10) Pub. No.: US 2007/0170887 A1
(43) Pub. Date: Jul. 26, 2007

(54) BATTERY/CAPACITOR CHARGER INTEGRATED IN IMPLANTABLE DEVICE

(75) Inventors: Robert S. Harguth, Ham Lake, MN (US); Keith R. Maile, New Brighton, MN (US); Michael J. Root, Lino Lakes, MN (US)

Correspondence Address: SCHWEGMAN, LUNDBERG, WOESSNER & KLUTH, P.A., P.O. BOX 2938, MINNEAPOLIS, MN, 55402, US

(73) Assignee: CARDIAC PACEMAKERS, INC., ST. PAUL, MN (US)

(21) Appl. No.: 11/611,643

(22) Filed: Dec. 15, 2006

Related U.S. Application Data
(60) Provisional application No. 60/750,515, filed on Dec. 15, 2005.

(51) Int. Cl. H02J 7/00

(52) U.S. Cl. 320/107

(57) ABSTRACT

A system and method for charging a rechargeable battery or capacitor in one implantable device using a charger located in a second implantable device is provided. One aspect of this disclosure relates to a system for charging a rechargeable component. The system includes at least one satellite implantable medical device, the satellite device including at least one rechargeable component. The system also includes a master implantable medical device adapted to communicate with the at least one satellite device. The master device includes a primary battery and a charger adapted to connect to the primary battery. The charger in the master device is adapted to charge the rechargeable component in the satellite device. The charger can charge the rechargeable component wirelessly, according to various embodiments. Other aspects and embodiments are provided herein.

### CROSS-REFERENCE TO RELATED APPLICATIONS

This application claims the benefit under 35 U.S.C. 119(e) of U.S. Provisional Patent Application Ser. No. 60/750,515, filed Dec. 15, 2005, the entire disclosure of which is hereby incorporated by reference in its entirety.

### TECHNICAL FIELD

This disclosure relates to implantable devices, and more particularly to systems and methods using chargers for batteries and capacitors in implantable medical devices.

### BACKGROUND

Certain implantable medical devices (IMDs) have been developed to operate using rechargeable batteries or capacitors. Examples include sensor devices that are not retrievable after implantation, inhibiting battery replacement and thus necessitating a battery that can be recharged to operate the device over the life of the patient.

One challenge with rechargeable batteries in IMDs is to ensure patient compliance, as neglect could cause complete battery discharge and corresponding device failure. In addition, recharging implanted batteries may require a visit to a medical provider, increasing a patient's cost, inconvenience and discomfort.

### SUMMARY

The above-mentioned problems and others not expressly discussed herein are addressed by the present subject matter and will be understood by reading and studying this specification.

One embodiment of the present subject matter includes a system for charging a rechargeable component in one IMD using a charger located in a second IMD. The system includes at least one satellite implantable medical device, the satellite device including at least one rechargeable component. The system also includes a master implantable medical device adapted to communicate with the at least one satellite device. According to various embodiments, the master device includes a battery and a charger adapted to connect to the primary battery. The charger is further adapted to provide electrical power from the primary battery to charge an electrical component, in various embodiments. The charger in the master device is also adapted to charge the rechargeable component in the satellite device, according to various embodiments. The charger can charge the rechargeable device using a wire connection, a radio frequency signal, an acoustic signal, or an inductive signal, according to various embodiments of the system.

One embodiment of the present subject matter provides a method for charging a rechargeable component within an IMD. The method includes providing at least one satellite implantable medical device having at least one rechargeable component. The method also includes providing a master implantable medical device adapted to communicate with the at least one satellite device, the master device having a primary battery and a charger adapted to connect to the primary battery. In the method, the charger is adapted to provide electrical power from the primary battery to charge an electrical component. The method further includes charging the rechargeable component in the satellite device using the charger in the master implantable medical device. According to various embodiments, charging the rechargeable component in the satellite device includes charging using a wired connection or a wireless signal.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE DRAWINGS

FIG. 1A illustrates a system for charging a rechargeable component in one IMD using a charger located in a second IMD, according to one embodiment.

FIG. 1B illustrates a wireless system for charging a rechargeable component in one IMD using a charger located in a second IMD, according to one embodiment.

FIG. 2 illustrates an implantable system for charging a rechargeable component in one IMD using a charger located in a second IMD, according to one embodiment.

FIG. 3 illustrates an IMD having a rechargeable component, according to one embodiment.

FIG. 4 illustrates a system with an IMD having an integrated charger, according to one embodiment.

FIG. 5 illustrates a programmer such as illustrated in the system of FIG. 4 or other external device to communicate with the IMD(s), according to one embodiment.

FIG. 6 illustrates a flow diagram of a method for charging a rechargeable component within an IMD, according to one embodiment.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The use of a rechargeable (or secondary) component (such as a rechargeable battery or capacitor) in an implantable medical device (IMD) creates challenges for recharging the component. These challenges include, but are not limited to: efficiently delivering adequate energy to the component in a minimal amount of time; ensuring that the charging is properly completed; and ensuring patient compliance. Use of an external charger, likely located at a patient's health care provider, requires that the burden for recharging the component is left to the patient and the provider. The physical recharging process reduces patient mobility and increases discomfort, as recharging could take hours to complete. In addition, the provider has to use valuable clinic space for the recharging, and the cost may or may not be reimbursable by an insurer. Several options exist to reduce the inconvenience of charging an implanted component, including improving efficiency of the charger (reducing the time to fully charge the component), reducing the physical size of the charger, and making the external charger mobile and easier to use. However, the patient would still be periodically subjected to a recharge regimen with an external apparatus. An improved system and method of recharging an IMD with a rechargeable component is needed.

The present disclosure provides a system and method for charging a rechargeable component in one IMD (satellite) using a charger located in a second IMD (master). A system where intra-body communication is enabled establishes a means by which energy can be transferred from one IMD to another. Recharging can then be performed on an “as needed” basis without the intervention of the patient or health care provider.

System for Reducing Proarrhythmic Effects of Neural Stimulation

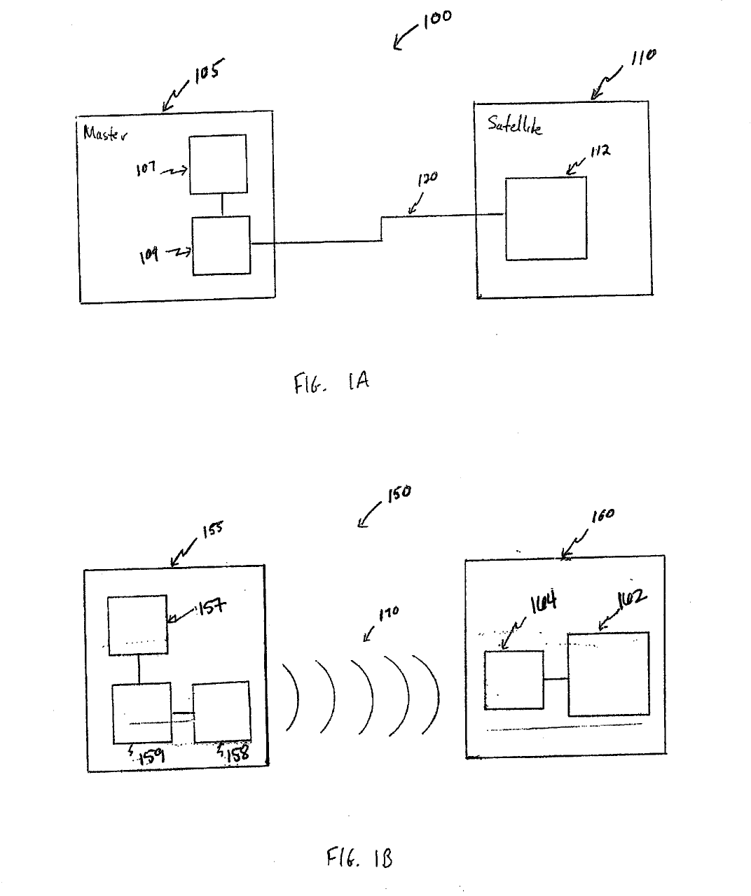

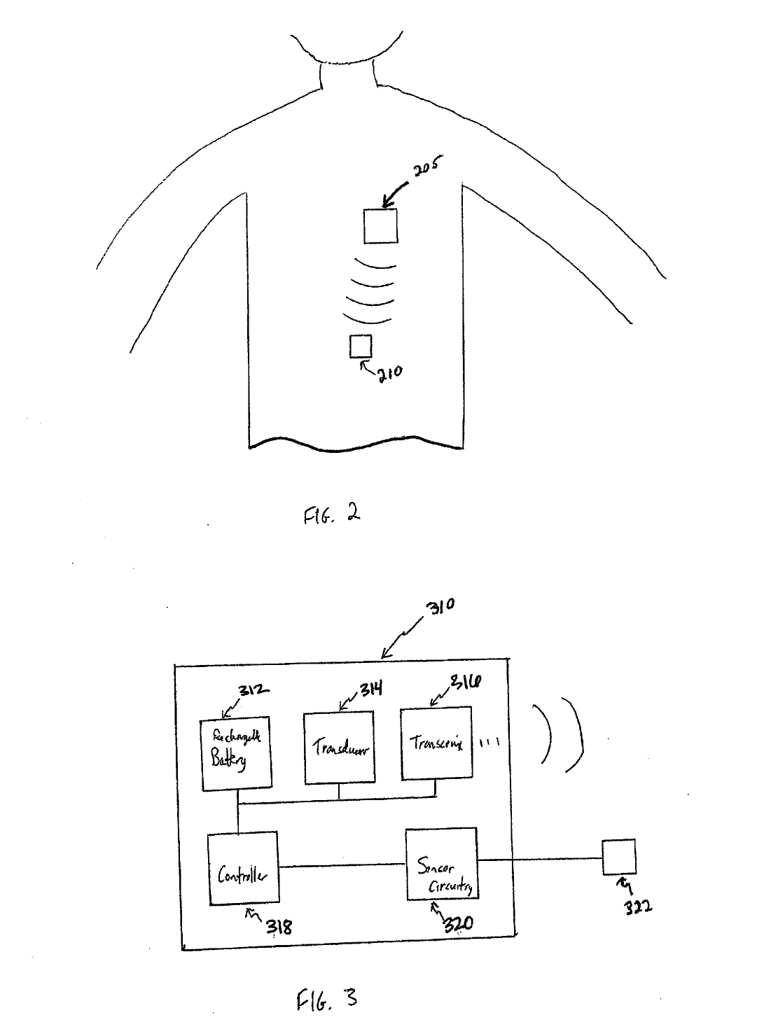

FIG. 1A illustrates a system for charging a rechargeable component in one IMD using a charger located in a second IMD, according to one embodiment. The system 100 includes at least one satellite implantable medical device 110. In various embodiments, the satellite device includes at least one rechargeable component 112. Rechargeable components include, but are not limited to, rechargeable batteries and capacitors. Additional embodiments of the satellite device include a primary battery. The system also includes a master implantable medical device 105 adapted to communicate with the at least one satellite device. According to various embodiments, the master device 105 includes a battery 107 and a charger 109 adapted to connect to the primary battery and further adapted to provide electrical power from the primary battery 107 to charge an electrical component. In various embodiments, the battery 107 is a primary battery. In additional embodiments, the battery 107 is a secondary battery. The charger 109 in the master device is adapted to charge the rechargeable component 112 in the satellite device, according to various embodiments.

The satellite implantable medical device includes a pressure sensor, according to one embodiment. Other types of satellite medical devices having a rechargeable component are within the scope of this disclosure. The master implantable medical device includes a cardiac rhythm management device, according to one embodiment. Other types of master implantable medical devices having a charger are within the scope of this disclosure. The master device and the satellite device may communicate over a wire connection 120, as shown in the depicted embodiment. Where the connection is wired, one or both of alternating current (AC) and direct current (DC) can be transmitted to the rechargeable component.

In addition to embodiments which use unilateral communication, in various embodiments, the system is adapted to enable bidirectional communication. One example of an application of the bidirectional capabilities of the system includes the so-called “lifeboat” situation, which involves sustaining the battery in a device in the event that patient compliance is deficient. If an IMD's battery were inadvertently allowed to discharge beyond a certain point, the IMD could go into a power saving mode and another IMD could transmit energy to keep the battery from completely discharging until a preferred recharging could be effected. This could reduce IMD malfunction. In some situations, this could reduce invasive procedures to replace damaged IMDs.

FIG. 1B illustrates a wireless system for charging a rechargeable component in one IMD using a charger located in a second IMD, according to one embodiment. The system 150 includes at least one satellite implantable medical device 160, the satellite device including at least one rechargeable component 162. The system also includes a master implantable medical device 155 adapted to communicate with the at least one satellite device via a wireless signal 170. According to various embodiments, the master device 155 includes a primary battery 157 and a charger 159 adapted to connect to the primary battery and further adapted to provide electrical power from the primary battery 157 to charge an electrical component. The charger 159 in the master device is adapted to charge the rechargeable component 162 in the satellite device, according to various embodiments.

According to the depicted embodiment, the master implantable medical device further includes a transducer 158 adapted to convert power into a wireless signal. In various embodiments, the satellite implantable medical device includes a transducer 164 adapted to convert the wireless signal into electrical power. One or both of the master and satellite devices include wireless transmitters and receivers, or transceiver circuitry, according to various embodiments. In various embodiments, one or both of the master and satellite devices are enabled to transmit and receive communications signals. In various embodiments, one or both of the master and satellite devices are enabled to transmit and receive power signals. In some embodiments, the communications signals and the power signals are transmitted and/or received with the same structural components.

The present illustrations show the charger 159 separate from the transducer 158, but it should be noted that the presents subject matter additionally extends to embodiments in which the charger 159 and the transducer 158 are integrated with one another.

According to various embodiments, the wireless signal 170 includes a radio frequency signal, and the master implantable medical device is adapted to provide a radio frequency signal to charge the rechargeable component in the satellite implantable medical device.

The wireless signal 170 includes an acoustic signal, and the master implantable medical device is adapted to provide an acoustic signal to charge the rechargeable component in the satellite implantable medical, according to one embodiment.

According to an embodiment, the wireless signal 170 includes an inductive signal, and the master implantable medical device is adapted to provide an inductive signal to charge the rechargeable component in the satellite implantable medical device.

The system is adapted to enable bidirectional or unidirectional communication. The master device has the capability to transmit adequate energy to recharge the component or to maintain the component at its current energy level, according to various embodiments of the present subject matter.

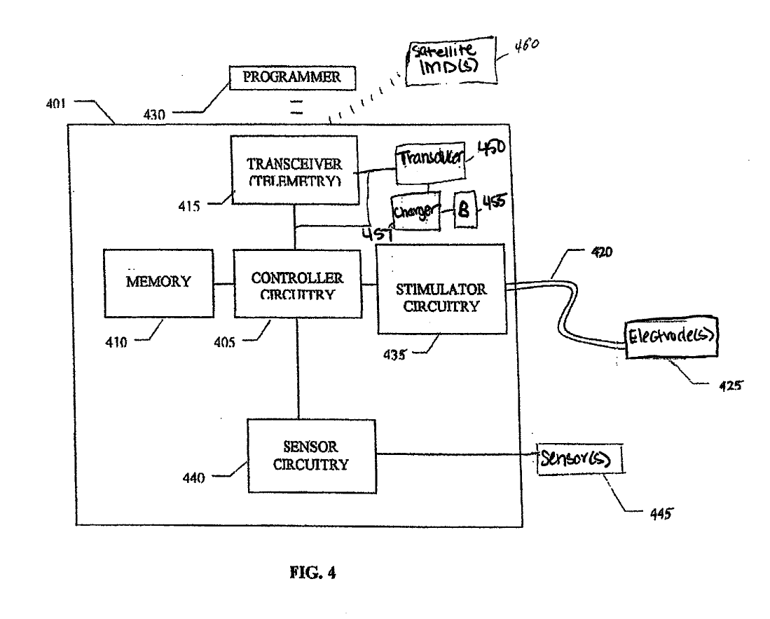

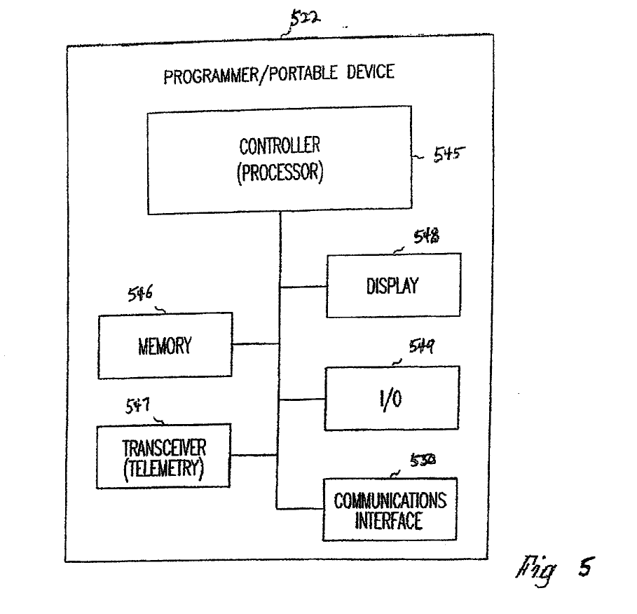

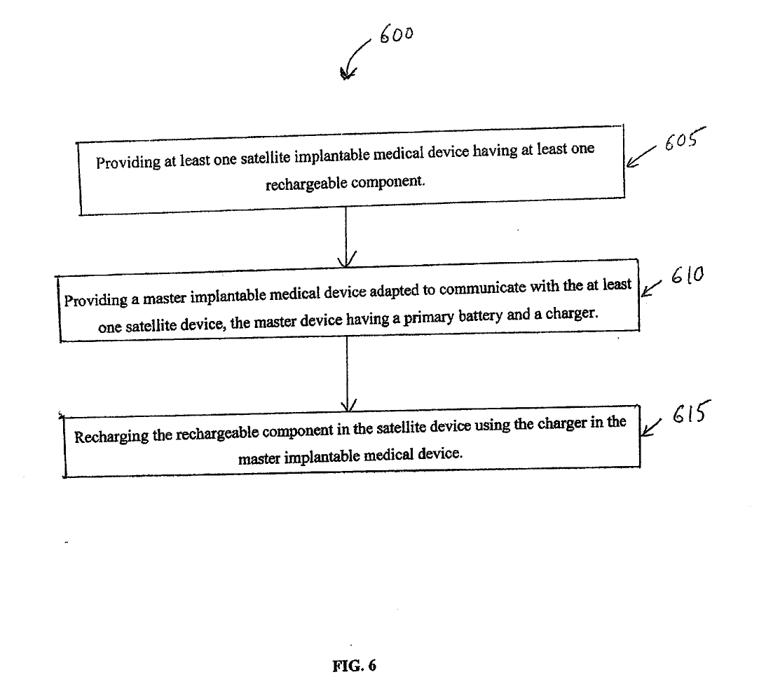

FIG. 2 illustrates an implantable system for charging a rechargeable component in one IMD using a charger located in a second IMD, according to one embodiment. A first, or master, implantable medical device 205 is shown wirelessly charging a rechargeable component within a second, or satellite implantable medical device 210 implanted within the same patient, using the method illustrated in FIG. 6, discussed below. An embodiment of the satellite device is depicted in FIG. 3, and an embodiment of the master device is depicted in FIG. 4, discussed below.

Implantable Medical Devices

FIG. 3 illustrates an IMD having a rechargeable component, according to one embodiment. The depicted IMD 310 (or satellite IMD) includes sensor circuitry 320 and operates as a satellite sensor module. However, other IMDs are within the scope of this disclosure and may function as a satellite IMD with the requirement that the IMD have at least one rechargeable component. The sensor circuitry 320 in this embodiment is electrically connected to at least one sensor 322, either wirelessly or via a physical lead. The IMD also includes a transceiver 316 for communicating with external devices. A rechargeable component (here rechargeable battery 312) within the IMD receives charging from an external device via the transceiver 316 and transducer 314, which is adapted to convert a wireless signal into electrical power. The transducer 314 includes rectifying circuitry to convert the AC signal to DC for charging the component. Although illustrated as being separate components, the present subject matter includes embodiments in which the transceiver and the transducer are structurally the same components. The present subject matter includes embodiments in which a wireless signal includes a power component. The present subject matter additionally includes embodiments in which a wireless signal includes a communications component. Embodiments are contemplated in which one signal carries both a communications component and a power component. These configurations are demonstrative of various embodiments of the present subject matter, but are not intended to be limiting of the range of embodiments contemplated by the presents subject matter, as other combinations not expressly recited herein are also used in various embodiments.

Controller circuitry 318 is operable to control operation of the IMD 310, including the sensing and recharging functions. Wireless signals contemplated by the present subject matter include, but is are not limited to, radio frequency, short range, long range, cellular, acoustic, inductive, or other wireless communication signals, according to various embodiments. In some embodiments of the present subject matter, the IMD 310 includes an implantable pressure sensor. In some of these embodiments, the implantable pressure sensor is not retrievable after implantation. Some of these embodiments benefit from occasional recharging cycles, and the present subject matter provides various recharging option for such systems.

FIG. 4 illustrates a system with an IMD having an integrated charger, according to one embodiment. The system includes an IMD (master IMD) 401, an electrical lead 420 coupled to the IMD 401, and at least one electrode 425. The master IMD includes a controller circuit 405, a memory circuit 410, a telemetry circuit 415, and a stimulation circuit 435. The controller circuit 405 is operable on instructions stored in the memory circuit to deliver an electrical stimulation therapy. Therapy is delivered by the stimulation circuit 435 through the lead 420 and the electrode(s) 425. The telemetry circuit 415 allows for transmitting to one or more satellite IMDs 460 to charge a rechargeable component in the satellite IMD, using an integrated charger 457. A transducer 450 is adapted to convert power from the master IMD battery 455 into a wireless signal.

The telemetry circuit 415 also allows for communication with an external programmer 430. The programmer 430 can be used to adjust the programmed therapy provided by the IMD 401, and the IMD can report device data (such as battery and lead resistance) and therapy data (such as sense and stimulation data) to the programmer using radio telemetry, for example. The programmer 430 can also be used to adjust the frequency, duration, quantity, and other parameters associated with charging rechargeable components in the satellite IMDs 460. According to various embodiments, the IMD 401 senses one or more physiological parameters and delivers stimulation therapy, such as cardiac rhythm management therapy. The illustrated system also includes sensor circuitry 440 that is coupled to at least one sensor 445. The controller circuit 405 processes sensor data from the sensor circuitry and delivers a therapy responsive to the sensor data.

An implantable heart monitor is one of the many applications for master IMDs incorporating one or more teachings of the present subject matter. As used herein, implantable heart monitor includes any implantable device for providing therapeutic stimulus to a heart muscle. Thus, for example, the term includes pacemakers, defibrillators, cardioverters, congestive heart failure devices, and combinations and permutations thereof. In addition to implantable heart monitors and other cardiac rhythm management devices, one or more teachings of the present invention can be incorporated into photographic flash equipment. Indeed, teachings of the invention are pertinent to any application where charging electrical components is desirable. Moreover, one or more teachings are applicable to power electronics and corresponding capacitors and batteries.

FIG. 5 illustrates a programmer such as illustrated in the system of FIG. 4 or other external device to communicate with the IMD(s), according to one embodiment. An example of another external device includes Personal Digital Assistants (PDAs) or personal laptop and desktop computers in a wireless patient monitoring network. The illustrated device 522 includes controller circuitry 545 and a memory 546. The controller circuitry 545 is capable of being implemented using hardware, software, and combinations of hardware and software. For example, according to various embodiments, the controller circuitry 545 includes a processor to perform instructions embedded in the memory 546 to perform a number of functions, including communicating data and/or programming instructions to the implantable devices. The illustrated device 522 further includes a transceiver 547 and associated circuitry for use to communicate with an implantable device. Various embodiments have wireless communication capabilities. For example, various embodiments of the transceiver 547 and associated circuitry include a telemetry coil for use to wirelessly communicate with an implantable device. The illustrated device 522 further includes a display 548, input/output (I/O) devices 549 such as a keyboard or mouse/pointer, and a communications interface 550 for use to communicate with other devices, such as over a communication network.

Methods of Reducing Proarrhythmic Effects of Neural Stimulation

FIG. 6 illustrates a flow diagram of a method for charging a rechargeable component within an IMD, according to one embodiment. The method 600 includes providing at least one satellite implantable medical device having at least one rechargeable component, at 605. The method also includes providing a master implantable medical device adapted to communicate with the at least one satellite device, the master device having a primary battery and a charger adapted to connect to the primary battery and further adapted to provide electrical power from the primary battery to charge an electrical component, at 610. The method further includes charging the rechargeable component in the satellite device using the charger in the master implantable medical device, at 615.

According to various embodiments, charging the rechargeable component in the satellite device includes charging the rechargeable component over a wired connection. Charging the rechargeable component in the satellite device includes charging the rechargeable component using a wireless signal, according to various embodiments. Examples of wireless signals include, but are not limited to radio frequency, acoustic and inductive signals. According to various embodiments, providing at least one satellite implantable medical device having at least one rechargeable component includes providing a satellite implantable medical device having a rechargeable battery, a rechargeable capacitor, or other type of component that requires electrical recharging for continued operation. Providing a master implantable medical device includes providing a cardiac rhythm management device, according to one embodiment. Other types of master and satellite implantable medical devices are within the scope of this disclosure.

Although specific embodiments have been illustrated and described herein, it will be appreciated by those of ordinary skill in the art that any arrangement which is calculated to achieve the same purpose may be substituted for the specific embodiment shown. This application is intended to cover adaptations or variations of the present subject matter. It is to be understood that the above description is intended to be illustrative, and not restrictive. Combinations of the above embodiments, and other embodiments will be apparent to those of skill in the art upon reviewing the above description. The scope of the present subject matter should be determined with reference to the appended claims, along with the full scope of equivalents to which such claims are entitled.

What is claimed is:

1. A system, comprising:
at least one satellite implantable medical device, the satellite device including at least one rechargeable component; and
a master implantable medical device adapted to communicate with the at least one satellite device, the master device including:
a battery; and
a charger adapted to connect to the primary battery and further adapted to provide electrical power from the primary battery to charge an electrical component;
wherein the charger in the master device is adapted to charge the rechargeable component in the satellite device.

2. The system of claim 1, wherein the battery of the master implantable medical device is a primary battery.

3. The system of claim 1, wherein the battery of the master implantable medical device is a secondary battery.

4. The system of claim 1, wherein the at least one rechargeable component includes a rechargeable battery for powering the satellite device.

5. The system of claim 1, wherein the at least one rechargeable component includes a capacitor.

6. The system of claim 1, wherein the at least one satellite implantable medical device includes a pressure sensor.

7. The system of claim 1, wherein the master implantable medical device includes a cardiac rhythm management device.

8. The system of claim 1, further comprising:
a wire connecting the master device to the satellite device, wherein the charger is adapted to charge the rechargeable component via the wire.

9. The system of claim 1, wherein the satellite device and the master device further include a wireless transmitter and a wireless receiver, and are adapted to communicate wirelessly.

10. The system of claim 9, wherein the master device and the satellite device are adapted to enable bidirectional communication.

11. The system of claim 9, wherein the master implantable medical device further includes a transducer adapted to convert battery power into a wireless signal and the satellite implantable medical device further includes a transducer adapted to convert the wireless signal into electrical power.

12. The system of claim 11, wherein the master implantable medical device is adapted to provide a radio frequency signal to charge the rechargeable component in the satellite implantable medical device.

13. The system of claim 11, wherein the master implantable medical device is adapted to provide an acoustic signal to charge the rechargeable component in the satellite implantable medical device.

14. The system of claim 11, wherein the master implantable medical device is adapted to provide an inductive signal to charge the rechargeable component in the satellite implantable medical device.

15. A method, comprising:
providing at least one satellite implantable medical device having at least one rechargeable component;
providing a master implantable medical device adapted to communicate with the at least one satellite device, the master device having a battery and a charger adapted to connect to the primary battery and further adapted to provide electrical power from the primary battery to charge an electrical component; and
charging the rechargeable component in the satellite device using the charger in the master implantable medical device.

16. The method of claim 15, wherein the battery of the master implantable medical device is a primary battery.

17. The method of claim 15, wherein the battery of the master implantable medical device is a secondary battery.

18. The method of claim 15, wherein charging the rechargeable component in the satellite device includes charging the rechargeable component using a radio frequency signal.

19. The method of claim 15, wherein charging the rechargeable component in the satellite device includes charging the rechargeable component using an acoustic signal.

20. The method of claim 15, wherein charging the rechargeable component in the satellite device includes charging the rechargeable component using an inductive signal.

21. The method of claim 15, wherein providing at least one satellite implantable medical device having at least one rechargeable component includes providing a satellite implantable medical device having a rechargeable battery.

22. The method of claim 15, wherein providing at least one satellite implantable medical device having at least one rechargeable component includes providing a satellite implantable medical device having a rechargeable capacitor.

23. A method, comprising:
powering an implantable master device with a primary battery;
powering at least one satellite implantable medical device with a secondary battery;
powering the at least one satellite implantable medical device using transduced signals conducted between the at least one satellite implantable medical device and the master implantable medical device; and
charging the secondary battery of the at least one satellite implantable using power derived from transduced wireless signals.

24. The method of claim 23, further comprising communicating therapy information between the implantable master device and the at least one satellite implantable medical device.

25. The method of claim 23, further comprising conducting the transduced signals over a wire connecting the master device to the satellite device.

26. The method of claim 23, further comprising transducing signals between the implantable master device and the at least one satellite implantable medical device wirelessly.

27. The method of claim 26, further comprising transducing signals between the implantable master device and the at least one satellite implantable medical device via radio frequency.
